(19) United States
(12) Patent Application Publication
(10) Pub. No.: US 2002/0017579 A1
(43) Pub. Date: Feb. 14, 2002

(54) Discharging apparatus for a shredder

(76) Inventor: Yung-Feng Wen, Taipei (TW)

Correspondence Address: WINSTON HSU, SF. 389, FU-HO ROAD, YUNGHO CITY, TAIPEI, TW

(21) Appl. No.: 09/732,296

(22) Filed: Dec. 8, 2000

(30) Foreign Application Priority Data
Aug. 11, 2000 (TW) 089116218

(51) Int. Cl. B02C 18/16

(52) U.S. Cl. 241/236

(57) ABSTRACT

A discharging apparatus for a shredder comprising two rotating axes installed in parallel within the shredder, two sets of cutters installed on their respective rotating axis and comprising a plurality of cutters to cut a document into strips, and two sets of spacers, each comprising a plurality of spacers positioned between two adjacent cutters to create gaps; at least one prominence is installed around at least one spacer to discharge the strips out of the spacer.

### BACKGROUND OF THE INVENTION

1. Field of the invention

The present invention relates to a shredder with the ability to cut a document into strips, and more particularly, to a shredder with the ability to discharge strips smoothly.

2. Description of the prior art

Please refer FIG. 1 to FIG. 3. FIG. 1 is a schematic diagram of a prior art shredder 10, FIG. 2 is a schematic diagram of interior components for the shredder 10, and FIG. 3 is a schematic diagram of a spacer for shredder 10.

The cross-cut shredder 10, used to cut a document into snowflake-like pieces, comprises a housing 12, two rotating axes 14 installed in parallel within the housing 12, two sets of cutters 16 installed on the two rotating axes 14 respectively, two sets of spacers 18, a directing structure 26 to direct the document through the two sets of cutters 16, and a motor 24 to drive the two rotating axes 14 by sets of gears (not shown) and to enable the two sets of cutters 16 to cut the document into snowflake-like pieces.

Each set of cutters 16 includes a plurality of cutters 20 to cut the document into snowflake-like pieces. Each set of spacers 18 includes a plurality of spacers 22 positioned between two adjacent cutters 20 to create gaps. The directing structure 26 includes a plurality of directing arms 32 protruding between two adjacent cutters 20 to direct the pieces out of the two sets of cutters 16.

The user puts the leading edge of the document into the upper opening 28 of the directing structure 26 and the motor 24 drives the two rotating axes 14 to simultaneously rotate in opposite directions.

Then, the two sets of cutters 16 installed on the two rotating axes 14 cut the document into snowflake-like pieces. The pieces are directed out of the two sets of cutters 16 by the directing arms 32 of the directing structure 26. The cutters 16 of FIG. 2 cut the document into pieces by a cross cut method, while other kinds of cutters cut documents into strips by a straight cut method. The straight cut method cannot be used by the directing arms 32 of FIG. 2 because some strips become stuck by attaching to the spacers 22 and being drawn into the gaps between the directing arms 32 and spacers 22. In a worst case scenario, operation of the motor 24 and therefore the shredder 10, is affected when the strips draw into the housing 12 of the shredder 10 and burn from contact with the motor 24.

### SUMMARY OF THE INVENTION

It is therefore a primary objective of the present invention to provide a shredder to discharge strips smoothly out of the housing and solve the problems mentioned above.

Briefly, this invention provides a discharging apparatus for a shredder comprising two rotating axes installed in parallel within the shredder, two sets of cutters installed on their respective rotating axis, comprising a plurality of cutters to cut the document into strips, two sets of spacers, each comprising a plurality of spacers positioned between two adjacent cutters to create gaps, and at least one prominence installed around at least one spacer to discharge the strips out of the spacer.

It is an advantage of the present invention that the strips are discharged smoothly out of the shredder and are prevented from being drawn into the motor due to the presence of prominences around the spacers.

This, and other objectives of the present invention, will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a schematic diagram of a prior art shredder.

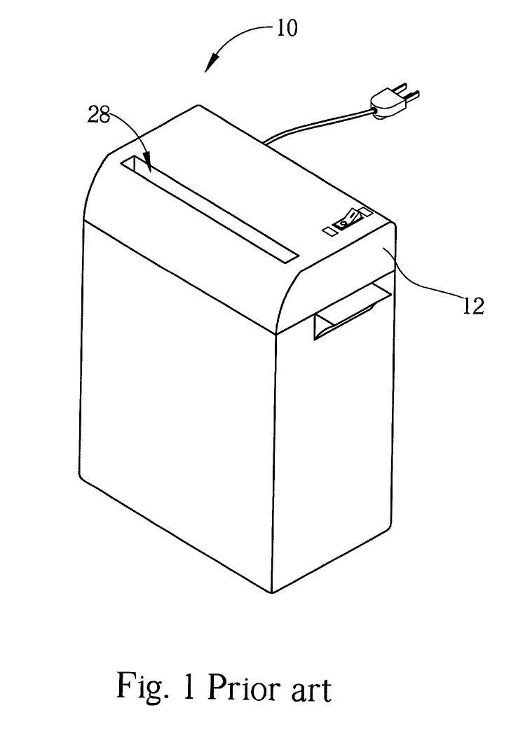

FIG. 2 is a schematic diagram of interior components for the shredder of FIG. 1.

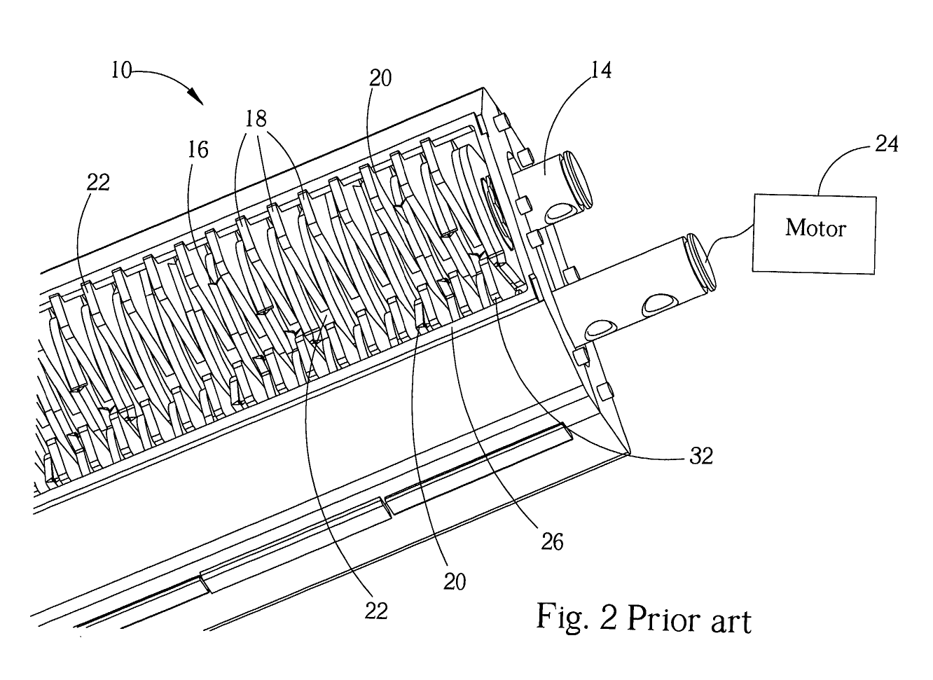

FIG. 3 is a schematic diagram of a spacer for the shredder of FIG. 1.

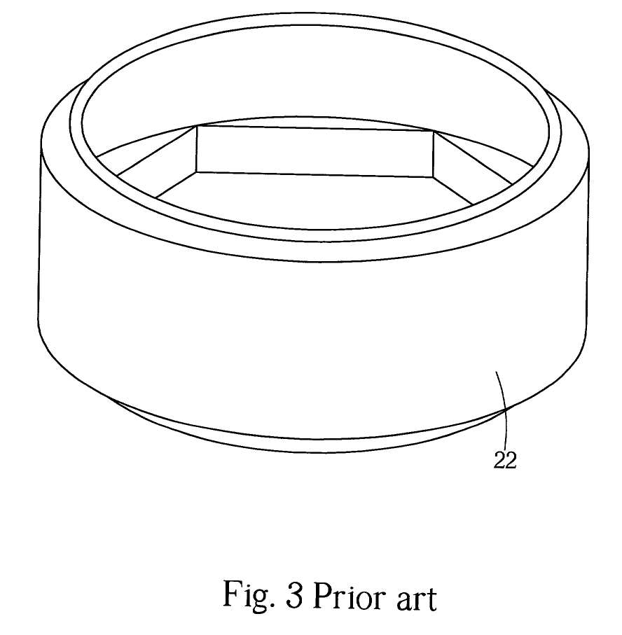

FIG. 4 is a schematic diagram of a shredder of the present invention.

FIG. 5 is a schematic diagram of interior components for the shredder of FIG. 4.

FIG. 6 is a schematic diagram of a spacer for the shredder of FIG. 4.

FIG. 7 is a schematic diagram of another embodiment of a spacer of FIG. 5.

### DETAILED DESCRIPTION OF THE PREFERRED EMBODIMENT

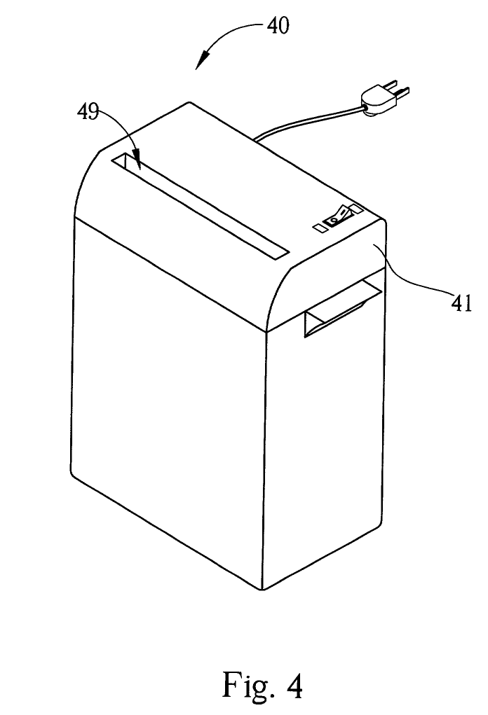

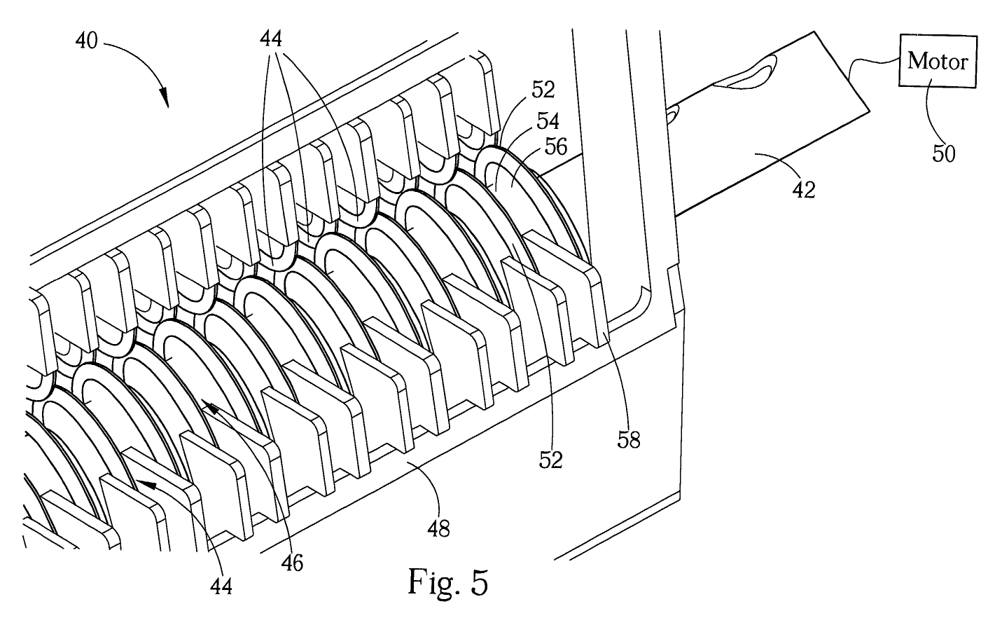

Please refer to FIG. 4 and FIG. 5. FIG. 4 is a schematic diagram of a shredder 40 of the present invention, and FIG. 5 is a schematic diagram of interior components for the shredder 40 of FIG. 4.

The shredder 40 used to cut a document into strips includes a housing 41, two rotating axes 42 installed in parallel within the housing 41, two sets of cutters 44 installed, on the two rotating axes 42 respectively, two sets of spacers 46, a directing structure 48 to direct the document through the two sets of cutters 44, and a motor 50 to drive the two rotating axes 42 and to enable the two sets of cutters to cut the document into strips.

Each set of cutters 44 includes a plurality of cutters 52 to cut the document into strips. Each set of spacers 46 includes a plurality of spacers 54, each positioned between two adjacent cutters 52, to create a gap between the two adjacent cutters 52. The directing structure 48 comprises a plurality of directing arms 58 protruding between two adjacent cutters 52 to direct the strips out of the two sets of cutters 44.

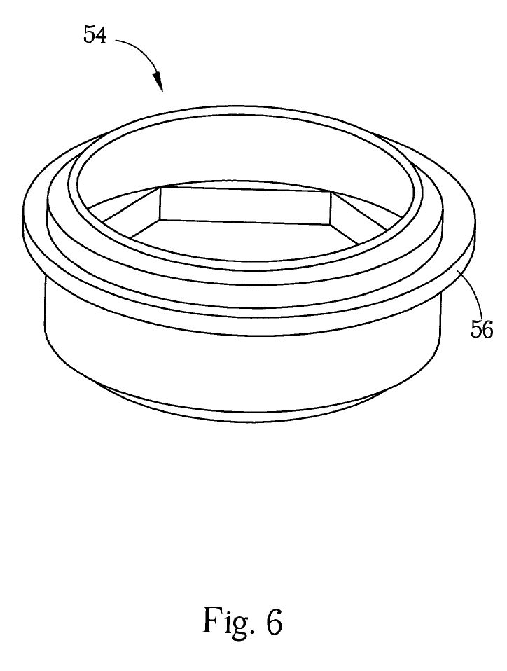

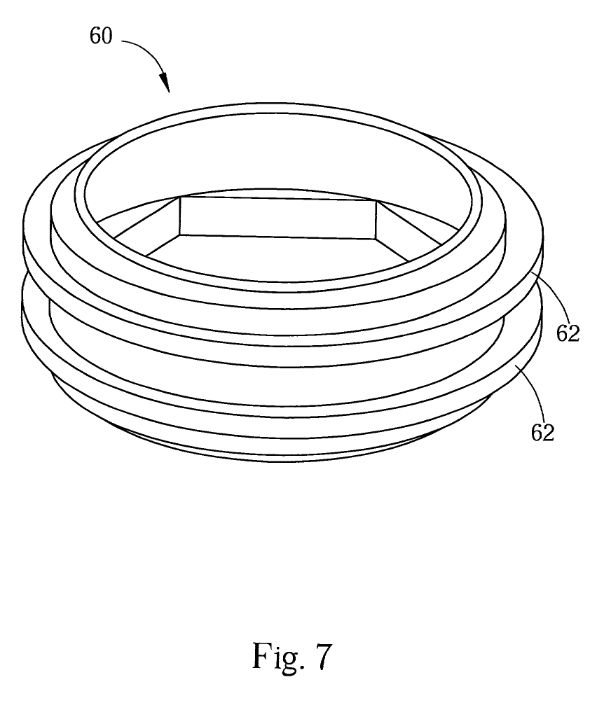

Please refer to FIG. 6. FIG. 6 is a schematic diagram of a spacer 54 for the shredder 40 of FIG. 4. A prominence 56 is installed around each spacer 54 to push the strips out of the spacer 54. The prominence 56 protrudes between the directing arm 58 and the cutter 52, as shown in FIG. 5. Please refer to FIG. 7. FIG. 7 is a schematic diagram of another spacer 60. Two prominences 62, installed around each spacer 60, are positioned between the directing arm 58 and its adjacent two cutters 52 to improve the release of the strips.

To cut a document, the user first puts the leading edge of the document into the upper opening 49 of the directing structure 48. The motor 50 enables the two rotating axes 42 to rotate in opposing directions by sets of gears (not shown), the two sets of cutters 44 cut the document into strips, and the directing structure 48 direct the strips out of the two sets of cutters 44.

In comparison with the prior art shredder 10, the shredder 40 of the present invention has the prominences 56 and 62 installed around the spacers 54 and 60, respectively. The prominences 56 and 62 push the strips out of the spacers 54 and 60 and keep the strips from becoming stuck between the directing arms 58 and the spacer 54 and 60 to affect the operation of the shredder 40. As well, the prominences 56 and 62 improve the operation of the shredder 40 by preventing strips from being drawn into the housing 41 of the shredder 40 and burning as a result of contact with the motor 50.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A discharging apparatus for a shredder comprising:
two rotating axes installed in parallel within the shredder;
two sets of cutters, both installed on their respective rotating axis and comprise a plurality of cutters to cut a document into strips; and
two sets of spacers, each comprises a plurality of spacers positioned between two adjacent cutters to create gaps; wherein at least one prominence is installed around at least one spacer for discharge of the strip.

2. The discharging apparatus of claim 1 wherein a prominence is installed around every spacer.

3. The discharging apparatus of claim 1 further comprises a directing structure to direct the strips through the two sets of cutters.

4. The discharging apparatus of claim 3 wherein the directing structure comprises at least one directing arm protruding between the two adjacent cutters to direct the strips out of the two sets of cutters.

5. The discharging apparatus of claim 4 wherein the prominence of the spacer protrudes between the directing arm and one of the two cutters.

6. The discharging apparatus of claim 4 wherein two prominences, set between the directing arm and its adjacent two cutters, are installed around every spacer.

7. The discharging apparatus of claim 1 further comprises a motor to drive the two rotating axes and to enable the two sets of cutters to cut the document into strips.

8. A shredder able to cut a document into strips comprising:
a housing;
two rotating axes installed in parallel within the housing;
two sets of cutters both installed on their respective rotating axis and comprise a plurality of cutters to cut the document into strips; and
two sets of spacers, each comprises a plurality of spacers positioned between two adjacent cutters to create gaps; wherein at least one prominence is installed around at least one spacer for discharge of the strips.

9. The shredder of claim 8 wherein a prominence is installed around every spacer.

10. The shredder of claim 8 further comprises a directing structure to direct the strips through the two sets of cutters.

11. The shredder of claim 10 wherein the directing structure comprises at least one directing arm protruding between two adjacent cutters to direct the strips out of the two sets of cutters.

12. The shredder of claim 11 wherein the prominence of the spacer protrude between the directing arm and one of the two cutters.

13. The shredder of claim 11 wherein two prominences, positioned between the directing arm and its adjacent two cutters, are installed around every spacer.

14. The shredder of claim 8 further comprises a motor to drive the two rotating axes and to enable the two sets of cutters to cut the document into strips.
